(19) United States
(12) Patent Application Publication
(10) Pub. No.: US 2013/0235755 A1
(43) Pub. Date: Sep. 12, 2013

(54) METHOD AND APPARATUS FOR PERFORMING MEASUREMENTS IN A MULTI CARRIER ENVIRONMENT

(71) Applicants: Kundan Kumar Lucky, Bangalore (IN); Venkateswara Rao Manepalli, Bangalore (IN)

(72) Inventors: Kundan Kumar Lucky, Bangalore (IN); Venkateswara Rao Manepalli, Bangalore (IN)

(73) Assignee: SAMSUNG ELECTRONICS CO. LTD., Suwon-si, Gyeonggi-do (KR)

(21) Appl. No.: 13/883,889

(22) PCT Filed: Nov. 8, 2011
(86) PCT No.: PCT/KR2011/008481

§ 371 Date: May 7, 2013

(30) Foreign Application Priority Data
Nov. 8, 2010 (IN) 3320/CHE/2010

(51) Int. Cl. H04W 24/04

(52) U.S. Cl. CPC H04W 24/04
USPC 370/252

(57) ABSTRACT

A method and apparatus for performing measurements in a multi-carrier environment are provided. In the method, a request to perform measurements on a frequency corresponding to one of at least one frequency band is received from a base station. It is determined whether a compressed mode is to be applied on the frequency corresponding to the one of the at least one frequency band based on capabilities of a user equipment. If so, the compressed mode is applied on the frequency corresponding to the one of the at least one frequency band so that measurements can be performed on the frequency corresponding to the one of the at least one frequency band without interrupting data activity on the remaining frequency bands. Otherwise, measurements are performed on the frequency corresponding to the one of the at least one frequency band without applying the compressed mode.

### PRIORITY

This application is a National Stage application under 35 U.S.C. §371 of an International application filed on Nov. 8, 2011 and assigned application No. PCT/KR2011/008481, and claims the benefit under 35 U.S.C. §365(b) of an Indian patent application filed on Nov. 8, 2010 in the Indian Intellectual Property Office and assigned Serial No. 3320/CHE/2010, the entire disclosure of which is hereby incorporated by reference.

### BACKGROUND OF THE INVENTION

1. Field of the Invention

The present invention relates to the field of wireless communication systems. More particularly, the present invention relates to performing measurements in a multi-carrier environment.

2. Description of the Related Art

In a cellular radio system according to the related art, a User Equipment (UE) communicates via a Radio Access Network (RAN) to one or more core networks. The UE comprises various types of equipments such as mobile telephones (also known as cellular or cell phones), laptops with wireless communication capability, Personal Digital Assistants (PDAs), and the like.

In a Universal Mobile Terrestrial System (UMTS), a UE communicates with a Radio Network Controller (RNC) over a set of supported frequency bands. Accordingly, the RNC configures the set of frequency bands for transmission/reception of Downlink (DL)/Uplink (UL) data to/from the UE. At any instance, the RAN may request UEs to perform measurements on a frequency corresponding to a frequency band. Each of the UEs may perform measurements on the requested frequency corresponding to the configured frequency band and communicate a measurement report to the RAN. For example, the RAN may utilize the received measurement report for optimizing network parameters (e.g., during a HandOver (HO)).

The UE may utilize a Compressed Mode (CM) when making measurements on another frequency (inter-frequency) or on a different inter Radio Access Technology (inter-RAT). Inter-frequency measurements are performed between channels of different frequencies within the same or a different UMTS band. Inter-RAT measurements are performed between channels of different Radio Access Technologies (e.g., GSM and UMTS).

In the compressed mode, transmission and reception by the UE over the frequency band configured for the UE is interrupted for a time period. This time period is commonly known as a transmission gap. In other words, the transmission gap is a time duration during which no UL or DL activity is performed. Thus, during the transmission gap, the UE performs measurements on the other frequency. Once the measurement has been performed, transmission and reception resumes on the frequency band on which the UE is camped.

According to the related art, the UE may perform data transmission and reception simultaneously over multiple frequency bands configured for the UE. For example in UMTS, Dual Band High Speed Downlink Packet Access (DB-HSDPA) involves High Speed Downlink Packet Access (HSDPA) channels being received on two carriers belonging to two different frequency bands. Similarly, Four Carrier High Speed Downlink Packet Access (4C-HSDPA) involves HSDPA channels being received on at most four carriers belonging to two frequency bands.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a Radio Access Network (RAN) that may request a User Equipment (UE) to perform measurements for a frequency corresponding to one of the configured frequency bands and report measurement reports back to the RAN. The UE may determine whether a compressed mode is required to be activated for performing measurements on the requested frequency band based on the capabilities of the UE. If the UE determines to utilize a compressed mode, the UE activates compressed mode for all the configured frequency bands for performing measurements on the requested frequency band. The application of the compressed mode on the non-requested frequency bands may interrupt data transmission and reception being performed over the frequency bands on which measurement are not requested by the RAN. A similar problem may exist in other wireless network systems such as Long Term Evolution (LTE) carrier aggregation network in which measurement gaps are activated for component carriers for which measurements are not requested along with component carrier(s) for which measurements are requested by an evolved Node B.

According to an aspect of the present invention a method for performing measurements in a Universal Mobile Terrestrial System (UMTS) network environment is provided. The method includes receiving a request from a base station to perform measurements on a frequency corresponding to one of at least one frequency band, determining whether a compressed mode is to be applied on the frequency corresponding to the one of the at least one frequency band based on capabilities of a user equipment, and if the compressed mode is to be applied on the at least one frequency corresponding to the one of the at least one frequency band, the compressed mode is applied on the frequency corresponding to the one of the at least one frequency band so that measurements can be performed on the frequency corresponding to the one of the at least one frequency band without interrupting data activity on the remaining frequency bands. Otherwise, measurements are performed on the frequency corresponding to the one of the at least one frequency band without applying the compressed mode.

According to an aspect of the invention, an apparatus is provided. The apparatus includes a processor, and a memory coupled to the processor, wherein the memory includes a measurement module configured for receiving a request from a base station to perform measurements on at least one frequency corresponding to one of at least one frequency band, determining whether a compressed mode is to be applied on the at least one frequency corresponding to the one of the at least one frequency band, if the compressed mode is to be applied on the at least one frequency corresponding to the one of the at least one frequency band, selectively applying the compressed mode on the at least one frequency corresponding to the one of the at least one frequency band so that measurements can be performed on the at least one frequency corresponding to the one of the at least one frequency band without interrupting data activity over the remaining frequency bands, and if the compressed mode is not to be applied on the at least one frequency corresponding to the one of the at least one frequency band, performing measurements on the at least one frequency corresponding to the one of the at least one frequency band without applying the compressed mode.

According to an aspect of the present invention, a method of performing measurements in a Long Term Evolution (LTE) network environment is provided. The method includes receiving a request from a base station to perform measurements on at least one frequency corresponding to one of at least one frequency band, determining whether a measurement gap is to be applied on the at least one frequency corresponding to the one of the at least one frequency band based on capabilities of a user equipment, and if the measurement gap is to be applied on the at least one frequency, selectively activating the measurement gap on the at least one frequency corresponding to the one of the at least one frequency band so that measurements can be performed on the at least one frequency corresponding to the one of the at least one frequency band without interrupting data communication between the user equipment and the base station on the remaining frequency bands.

According to an aspect of the present invention, an apparatus is provided. The apparatus includes a processor, and a memory coupled to the processor, wherein the memory includes a measurement module configured for receiving a request from a base station to perform measurements on at least one frequency corresponding to one of at least one frequency band, determining whether a measurement gap is to be applied on the at least one frequency corresponding to the one of the at least one frequency band, if the measurement gap is to be applied on the at least one frequency, selectively activating the measurement gap on the at least one frequency corresponding to the one of the at least one frequency band so that measurements can be performed on the at least one frequency corresponding to the one of the at least one frequency band without interrupting data activity over the remaining frequency bands, and if the measurement gap is not to be applied on the at least one frequency, performing measurements on the at least one frequency corresponding to the one of the at least one frequency band without activating the measurement gap.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a block diagram of a wireless communication system for performing measurements on frequency bands, according to an exemplary embodiment of the present invention.

FIG. 2 is a process flowchart of a method of performing measurements on frequencies of frequency bands in a Universal Mobile Terrestrial System (UMTS) network environment, according to an exemplary embodiment of the present invention.

FIG. 3 is a process flowchart of a method of performing measurements on frequencies of frequency bands in a Long Term Evolution (LTE) network environment, according to another exemplary embodiment of the present invention.

FIG. 4 illustrates a block diagram of a User Equipment (UE) showing various components according to exemplary embodiments of the present invention.

Throughout the drawings, it should be noted that like reference numbers are used to depict the same or similar elements, features, and structures

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

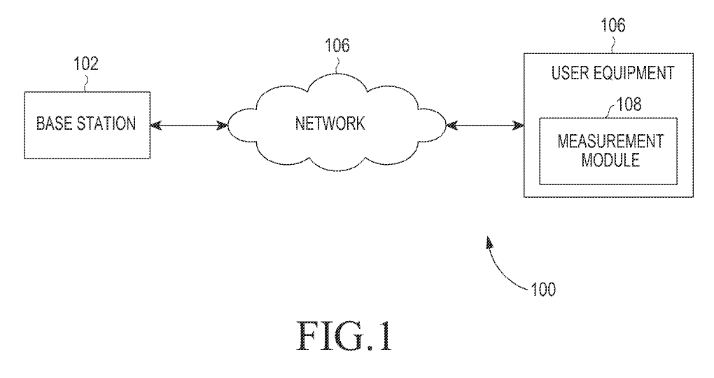

FIG. 1 illustrates a block diagram of a wireless communication system for performing measurements on frequency bands, according to an exemplary embodiment of the present invention.

Referring to FIG. 1, the wireless communication system 100 includes a base station 102, a User Equipment (UE) 104, and a wireless network 106. The UE 104 includes a measurement module 108 for performing measurements on frequencies of a desired frequency band(s) in a multi-carrier environment.

The base station 102 may be an evolved node B (eNB) for a Long Term Evolution (LTE) network or a Node B for a Universal Mobile Terrestrial System (UMTS) network. The UE 104 may be a cell phone, personal digital assistants, smart phones, laptop with wireless connectivity, tablets and the like capable of performing measurements on supported frequency bands and reporting to the base station 102. The wireless network 106 may be a LTE network, a UMTS network, or any other wireless network requiring the UE 104 to perform measurements on the supported frequency bands.

According to exemplary embodiments of the present invention, the UE 104 may indicate a set of frequency bands supported for data transmission and reception in uplink and downlink to a Radio Network Controller (RNC) (not shown) of the UMTS network via the base station 102. The RNC may configure the set of frequency bands supported by the UE 104 for communicating data packets in uplink and downlink. For optimization of the wireless network 106, the RNC may require the UE 104 to perform measurements on a frequency corresponding to a desired frequency band. Accordingly, the UE 104 receives a request from the base station 102 to perform measurements on the frequency corresponding to the desired frequency band.

Based on the request from the base station 102 to perform measurements on the frequency corresponding to the desired frequency band, the measurement module 108 determines whether the requested frequency is associated with a configured frequency band. If the requested frequency corresponds to the configured frequency band, then the measurement module 108 determines whether a compressed mode is to be applied on the frequency of the desired frequency band based on capabilities of the UE 104. If so, the measurement module 108 selectively applies the compressed mode on the frequency of the desired frequency band and performs measurements on the desired frequency corresponding to the desired frequency band in transmission gaps formed during the compressed mode. Otherwise, the measurement module 108 performs measurements on the desired frequency corresponding to the frequency band without applying the compressed mode. Accordingly, the UE 104 communicates a measurement report comprising the measurements performed on the frequency of the desired frequency band to the base station 102.

According to exemplary embodiments of the present invention, the measurement module 108 need not apply a compressed mode on the entire set of frequencies in all the frequency bands configured for the UE 104 when a request for performing measurements on at least one frequency corresponding to one of the configured frequency bands is received from the base station 102. This helps avoid interruptions in data transmission and reception over the non-requested frequency bands configured for the UE 104. For example, in a case of Dual Band High Speed Downlink Packet Access (DB-HSDPA), the measurement module 108 applies a compressed mode on at least one of the dual frequency bands configured for the UE 104. Similarly, in a case of Four Carrier High Speed Downlink Packet Access (4C-HSDPA), the measurement module 108 applies a compressed mode to a desired carrier(s) from the four carriers corresponding to the two frequency bands.

If the measurement module 108 determines that the desired frequency band does not correspond to one of the configured frequency bands, then the measurement module 108 applies a compressed mode to all the configured frequency bands supported by the UE 104. Accordingly, the measurement module 108 performs measurements on the frequency associated with each of the frequency bands in transmission gaps. Then, the UE 104 communicates a measurement report comprising the measurement information to the base station 102.

The above process can also be applied to frequency bands while performing measurements in a LTE network. For example, the UE 104 may indicate a set of frequency bands supported for data transmission and reception in uplink and downlink to the base station 102. The base station 102 may configure the set of frequency bands supported by the UE 104 for communicating data packets in uplink and downlink. For optimizing the wireless network 106, the base station 102 may require the UE 104 to perform measurements on frequencies corresponding to a selective frequency band. Accordingly, the UE 104 receives a request from the base station 102 to perform measurements on the frequency corresponding to the desired frequency band.

Based on the request, the measurement module 108 determines whether the requested frequency in the associated band can be measured without applying measurement gap based on capabilities of the UE 104 utilizing the unused set of component carriers and the corresponding RF chains if the UE CA capability is spanning more than one frequency band or the UE 104 having additional capability in receiving/measuring a contiguous frequency than that is being currently configured. If so, the measurement module 108 performs measurements on the frequency corresponding to the desired frequency band without activating the measurement gap. Otherwise, the measurement module 108 activates the measurement gap on all the configured frequencies or on the selected frequency/frequencies of the desired frequency band and performs measurements on the frequency corresponding to the desired frequency band. Accordingly, the UE 104 communicates a measurement report comprising the measurements performed on the desired frequency band to the base station 102.

According to exemplary embodiments of the present invention, the measurement module 108 need not activate a measurement gap on the entire set of frequencies of frequency bands configured for the UE 104 when a request for performing measurements on a specific frequency corresponding to one of the configured frequency bands is received from the base station 102. This helps avoid interruptions in data transmission and reception over the non-requested frequency bands configured for the UE 104. In other words, the base station 102 and the UE 104 continue to perform data activity on carriers associated with the frequency bands on which the compressed mode is not applied.

If the measurement module 108 determines that the frequency band associated with the frequency to be measured is not one of the configured frequency band, then the measurement module 108 activates a measurement gap on all the configured frequency bands supported by the UE 104. Accordingly, the measurement module 108 performs measurements on the frequency associated with each of the frequency bands. Then, the UE 104 communicates a measurement report comprising the measurement information to the base station 102.

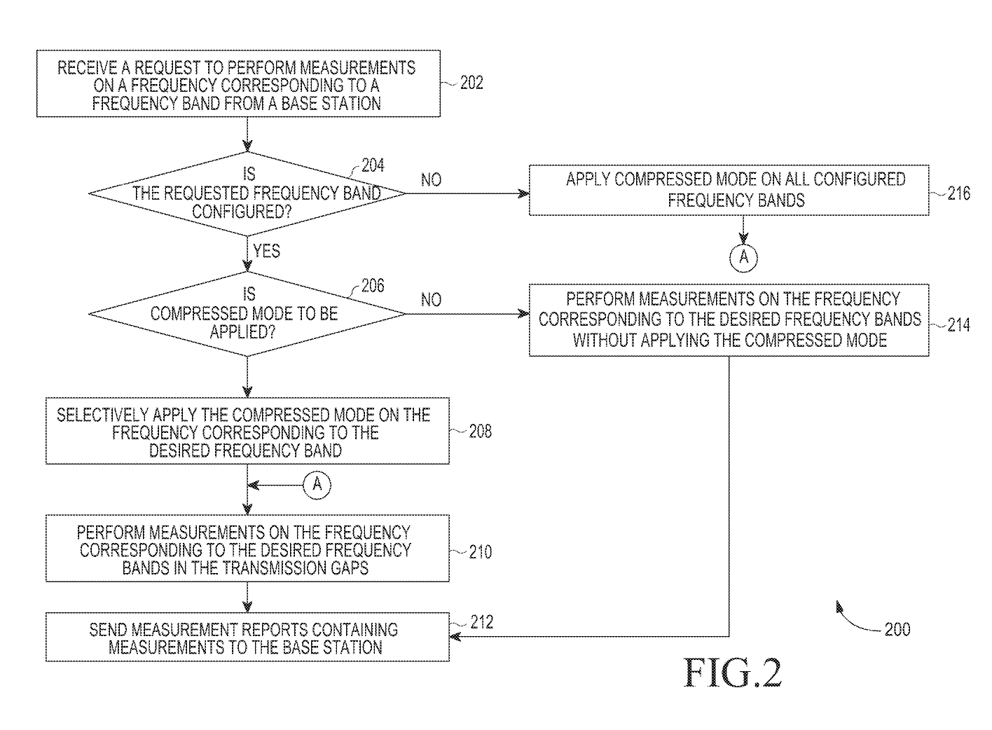

FIG. 2 is a process flowchart 200 of a method of performing measurements on frequencies of frequency bands in a UMTS network environment, according to an exemplary embodiment of the present invention.

Referring to FIG. 2, at step 202, a request to perform measurements on a frequency corresponding to a desired frequency band is received from the base station 102. At step 204, it is determined whether the frequency band corresponding to the frequency to be measured corresponds to one of the frequency bands configured for the UE 104. If the selected frequency band corresponds to one of the frequency bands configured for the UE 104, then the procedure proceeds to step 206. At step 206, it is determined whether a compressed mode is to be applied on the frequency of the frequency band based on capabilities of the UE 104. If it is determined that the compressed mode is to be applied on the frequency of the frequency band at step 206, then the procedure proceeds to step 208 at which the compressed mode is selectively applied on the frequency of the desired frequency band. In other words, the compressed mode is applied on the frequency/frequencies corresponding to the desired frequency band and not on the remaining frequency bands. Thus, data activity can be performed on the frequencies of the remaining frequency bands on which the compressed mode is not applied in an uninterrupted manner.

According to exemplary embodiments of the present invention, the compressed mode is selectively applied on one or more carriers corresponding to the desired frequency band. The compressed mode is selectively applied per carrier corresponding to the desired frequency band based on a carrier index. The carrier index is provided in an Information Elements (IEs) Dedicated Physical Channel (DPCH) compressed mode information and/or DPCH compressed mode status information. Thus, using the carrier index information, signaling is achieved in the following ways:

In the first case, the above defined set of messages configures the compressed mode with the DPCH compressed mode information. The carrier index is added to the DPCH compressed mode status information which is part of measurement control information message. In this case, though the UTMS network can configure compressed mode transmission gap pattern and make the compressed mode transmission gap pattern to be in a deactivated state. Later, according to the measurement requirement, the base station 102 when triggering a measurement control message can activate the compressed mode transmission gap pattern per carrier including a new carrier index as part of the DPCH compressed mode status information.

In another case, the above defined set of messages configures the compressed mode with the DPCH compressed mode information which also includes the carrier index. In such a case, the base station 102 configures a compressed mode transmission gap pattern per carrier or group of carriers. Later, when the base station 102 triggers a measurement control message to perform measurements for a frequency corresponding to a frequency band, the UE 104 activates the compressed mode only on the carriers that belong to a particular frequency band where the measurements need to be performed according to the compressed mode transmission gap pattern set for the corresponding carriers.

In yet another case, the IEs DPCH compressed mode information and the DPCH compressed mode status information includes a new carrier index. Accordingly, the compressed mode is activated and/or deactivated on the carriers using the new carrier index.

According to exemplary embodiments of the present invention, when configuring a compressed mode per carrier or a group of carriers, compressed mode transmission gap pattern parameters can be set such that the entire UE 104 (e.g., all the carriers or the frequency bands that are operating) need not be moved to the compressed mode, thereby causing data disruption on the frequency bands. This can be achieved by defining different sets of CM parameters for the carriers belonging to different frequency bands.

If the compressed mode is required and configured by the base station 102, applicability of the compressed mode on the carriers corresponding to the desired frequency band is reported to the base station 102. The applicability of the compressed mode is reported at the compressed mode configuration performed with the above mentioned messages or upon reception of a measurement control message.

At step 210, measurements are performed on the frequency corresponding to the frequency band in transmission gaps formed during the compressed mode. At step 212, a measurement report comprising the measurements associated with the frequency corresponding to the frequency band is sent to the base station 102.

In contrast, if it is determined that the compressed mode is not to be applied on the frequency of the frequency band at step 206, then the procedure proceeds to step 214. At step 214, measurements are performed on the frequency corresponding to the frequency band without applying the compressed mode on the frequency and thereafter, the procedure proceeds to step 212.

If, at step 204, it is determined that the frequency band is not configured for the UE 104 and a compressed mode is required to perform measurements according to capabilities of the UE 104, then the procedure proceeds to step 216. At step 216, a compressed mode applied substantially simultaneously on the configured frequency bands and thereafter, the procedure proceeds to step 210. Alternatively, when the frequency band is not configured for the UE 104 and a compressed mode is required to perform measurements according to the capabilities of the UE 104, the compressed mode may be configured on the carriers of one of the frequency bands by the base station 102, where a radio frequency chain is shared between a frequency band configured for the UE 104 and the frequency band associated with the frequency on which measurements are to be performed, thereby allowing carriers of the configured frequency bands to be used for data transmission and reception. The base station 102 obtains the RF chain split information based on the frequency band combinations supported by the UE 104. Alternatively, the UE 104 communicates the RF chain split information to the base station 102 prior to receiving the request for performing measurements on a frequency corresponding to a frequency band.

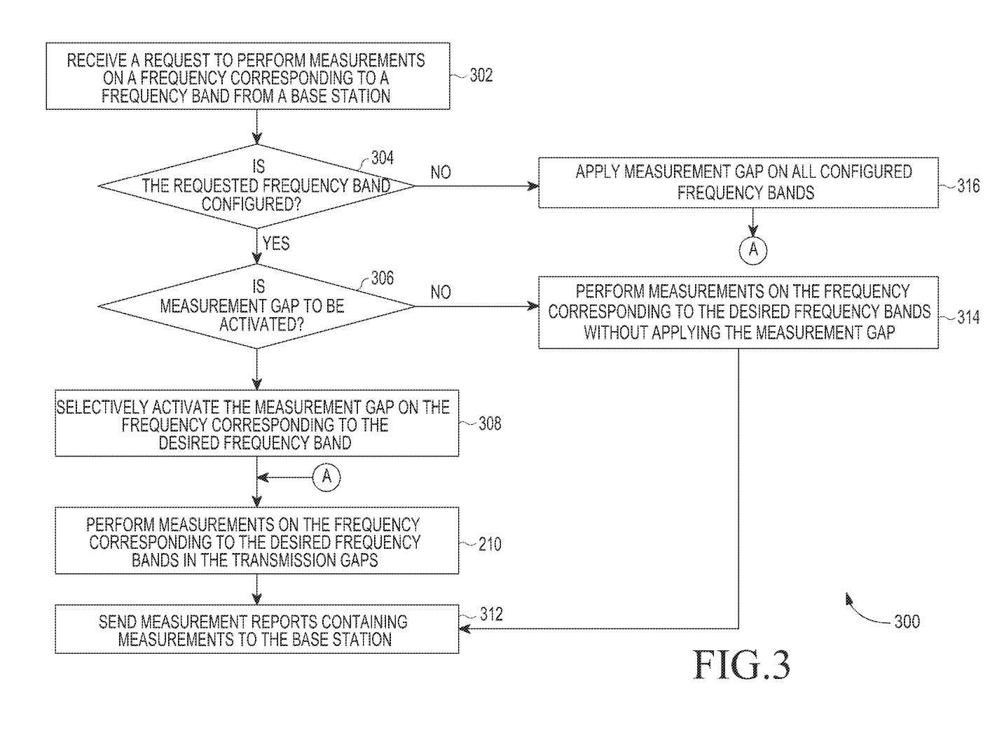

FIG. 3 is a process flowchart 300 of a method of performing measurements on frequencies of frequency bands in an LTE network environment, according to another exemplary embodiment of the present invention.

Referring to FIG. 3, at step 302, a request to perform measurements on a frequency corresponding to a desired frequency band is received from the base station 102. At step 304, it is determined whether the frequency band corresponding to the frequency to be measured corresponds to one of the frequency bands configured for the UE 104. If the selected frequency band corresponds to one of the frequency bands configured for the UE 104, then the procedure proceeds to step 306. At step 306, it is determined whether a measurement gap is to be activated on the frequency of the desired frequency band based on capabilities of the UE 104. If it is determined that a measurement gap is to be activated on the frequency of the desired frequency band at step 306, then the procedure proceeds to step 308 at which a measurement gap is selectively activated on the frequency of the frequency band. In other words, the measurement gap is activated on the frequency/frequencies corresponding to the desired frequency band and not on the remaining frequency bands. Thus, data activity can be performed on the frequencies of the remaining frequency bands on which the measurement gap is not activated in an uninterrupted manner.

The measurement gap is activated for all the component carriers in a frequency band. Alternatively, the measurement gap is activated for one or more component carriers among a set of component carriers. For example, the measurement gap is activated per carrier in such a way that at least one component carrier in the component carriers is active so that data activity between the UE 104 and the base station 102 is not interrupted. An activation time based on System Frame Number (SFN) or gap offset differing from configuration to configuration can be used in order to interleave the measurement gap patterns across the component carriers.

According to an exemplary embodiment of the present invention, the measurement gap is activated for one or more component carriers corresponding to a particular frequency band based on an IE cell index and/or measurement gap configuration information element. The IE cell index and/or measurement gap configuration information element is added to measurement object information element, report configuration information element, or a measurement identifier information element. According to such an exemplary embodiment of the present invention, if the IE cell index is applied to a measurement object, then the corresponding component carriers can use a common measurement gap configuration.

According to an exemplary embodiment of the present invention, a new information element can be defined as part of measurement configuration information element which may link the measurement objects, measurement identifiers, report configuration, and/or the measurement gap configurations applicable with a corresponding IE cell index where the measurement gap is to be applied. According to another exemplary embodiment of the preset invention, a new information element can be defined as part of measurement configuration information element which may link measurement objects, measurement identifiers, and/or report configuration and the IE cell index which configures a measurement gap for that combination.

If the measurement gap is required and configured by the base station 102, applicability of the measurement gap on a set of component carriers corresponding to the desired frequency band is reported to the base station 102. The applicability of the measurement gaps is reported in a radio resource connection reconfiguration complete message.

At step 310, measurements are performed on the frequency corresponding to the desired frequency band in the measurement gaps. At step 312, a measurement report comprising the measurements associated with the frequency corresponding to the desired frequency band is sent to the base station 102.

If it is determined that the measurement gap is not to be activated on the frequency of the desired frequency band at step 306, then the procedure proceeds to step 314, at which measurements are performed on the frequency corresponding to the desired frequency band without activating the measurement gap on the desired frequency. Thereafter, the procedure proceeds to step 312.

According to an exemplary embodiment of the present invention, measurements are performed on the frequency of the desired frequency bands using deactivated and non-configured component carriers (component carriers under capability of the UE 104).

According to an exemplary embodiment of the present invention, measurements are performed on the frequency of the desired frequency bands using a deactivated secondary cell. For example, the secondary cell may be deactivated for performing measurements on the frequency without activating measurement gap on the frequency.

If, at step 304, it is determined that the selected frequency band does not correspond to one of the frequency bands configured for the UE 104 and a measurement gap is required to perform measurements according to capabilities of the UE 104, then at step 316, a measurement gap is activated substantially simultaneously on the configured frequency bands. Thereafter, the procedure proceeds to step 310. Alternatively, when the frequency band is not configured for the UE 104 and a measurement gap is required to perform measurements according to the capabilities of the UE 104, the measurement gap is configured on the carriers of the frequency bands by the base station 102, where a radio frequency chain is shared between a frequency band configured for the UE 104 and the frequency band associated with the frequency on which measurements are to be performed, thereby allowing carriers of the configured frequency bands to be used for data transmission and reception. The base station 102 obtains the RF chain split information based on the frequency band combinations supported by the UE 104. Alternatively, the UE 104 communicates the RF chain split information to the base station 102 prior to receiving the request for performing measurements on a frequency corresponding to a frequency band.

When a measurement request for a frequency is received, the UE 104 can perform measurements on said frequency without activating measurement gaps using unused set of CCs and the corresponding RF chains if the UE CA capability is spanning more than one band or the UE having more capability in receiving/measuring a contiguous frequency than that is being currently configured. This can be communicated to the base station 102 as part of UE capability.

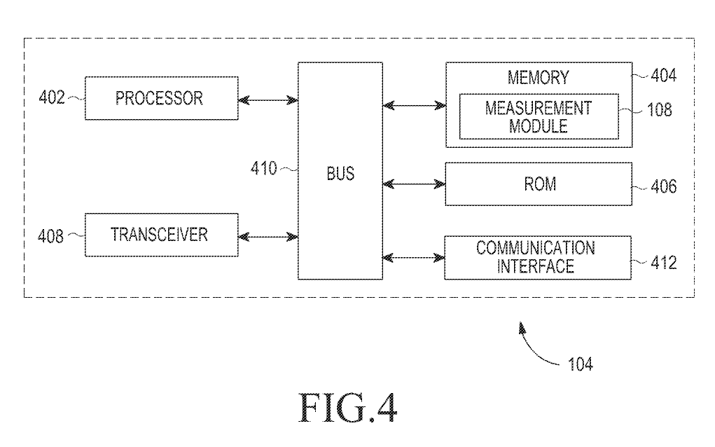

FIG. 4 illustrates a block diagram of a UE showing various components according to exemplary embodiments of the present invention.

Referring to FIG. 4, the UE 104 includes a processor 402, a memory 404, a Read Only Memory (ROM) 406, a transceiver 408, a bus 410, and a communication interface 412.

The processor 402, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 402 may also include embedded controllers, such as generic or programmable logic devices or arrays, application specific integrated circuits, single-chip computers, smart cards, and the like.

The memory 404 may be volatile memory and non-volatile memory. The memory 404 includes the measurement module 108 for performing measurements on frequencies of frequency bands, according to the exemplary embodiments of the present invention illustrated in FIGS. 1-3. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling memory cards, Memory Sticks™, and the like. The memory may include a non-transitory computer-readable storage medium.

Exemplary embodiments of the present invention may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 402. For example, a computer program may include machine-readable instructions capable of performing measurements on frequencies of selected frequency bands, according to the teachings and herein described exemplary embodiments of the present invention. According to an exemplary embodiment of the present invention, the computer program may be included on a non-transient computer-readable storage medium and loaded from the storage medium to a hard drive in the non-volatile memory.

The present invention has been described with reference to exemplary embodiments. However, it will be evident that various modifications and changes may be made to these exemplary embodiments without departing from the broader spirit and scope of the invention. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

1. A method of performing measurements in a Universal Mobile Terrestrial System (UMTS) network environment comprising:
receiving a request from a base station to perform measurements on at least one frequency corresponding to one of at least one frequency band;
determining whether a compressed mode is to be applied on the at least one frequency corresponding to the one of the at least one frequency band based on capabilities of a user equipment; and
if the compressed mode is to be applied on the at least one frequency corresponding to the one of the at least one frequency band, selectively applying the compressed mode on the at least one frequency corresponding to the one of the at least one frequency band so that measurements can be performed on the at least one frequency corresponding to the one of the at least one frequency band without interrupting data communication between the user equipment and the base station on the remaining frequency bands.

2. The method of claim 1, wherein the determining of whether the compressed mode is to be applied on the at least one frequency corresponding to the one of the at least one frequency band based on capabilities of the user equipment comprises:
if the compressed mode is not to be applied on the at least one frequency, performing measurements on the at least one frequency corresponding to the one of the at least one frequency band without applying the compressed mode.

3. The method of claim 1, wherein the receiving of the request from the base station to perform measurements on the at least one frequency corresponding to the one of the at least one frequency band comprises:
determining whether the one of the at least one frequency band is configured for the user equipment to communicate with the base station;
if the one of the at least one frequency band is configured for the user equipment to communicate with the base station, determining whether the compressed mode is to be applied on at least one frequency corresponding to the one of the at least one frequency band based on the capabilities of the user equipment; and
if the one of the at least one frequency band is not configured for the user equipment to communicate with the base station, simultaneously applying a compressed mode on each of the configured frequency bands.

4. The method of claim 3, wherein the selectively applying of the compressed mode on the at least one frequency corresponding to the one of the at least one frequency band comprises:
selectively applying the compressed mode on one or more carriers associated with one of a first frequency band and a second frequency band when a Radio Frequency (RF) chain in the user equipment is shared between the first frequency band and the second frequency band, wherein the first frequency band corresponds to a frequency band that is configured for the user equipment to communicate with the base station, and wherein the second frequency band to a frequency band on which measurements are to be performed.

5. The method of claim 4, wherein the selectively applying of the compressed mode on the carriers associated with one of the first frequency band and the second frequency band when the RF chain in the user equipment is shared between the first frequency band and the second frequency band comprises:
communicating a RF chain split information associated with the user equipment to the base station.

6. The method of claim 3, wherein the selectively applying of the compressed mode on the at least one frequency corresponding to the one of the at least one frequency band comprises:
selectively applying the compressed mode on one or more carriers associated with the one of the at least one frequency band using an information element carrier index.

7. The method of claim 1, further comprising:
reporting applicability of a compressed mode on the at least one frequency corresponding to the one of the at least one frequency band to the base station.

8. An apparatus comprising:
a processor; and
a memory coupled to the processor, wherein the memory includes a measurement module configured for:
receiving a request from a base station to perform measurements on at least one frequency corresponding to one of at least one frequency band;
determining whether a compressed mode is to be applied on the at least one frequency corresponding to the one of the at least one frequency band;
if the compressed mode is to be applied on the at least one frequency corresponding to the one of the at least one frequency band, selectively applying the compressed mode on the at least one frequency corresponding to the one of the at least one frequency band so that measurements can be performed on the at least one frequency corresponding to the one of the at least one frequency band without interrupting data activity over the remaining frequency bands; and
if the compressed mode is not to be applied on the at least one frequency corresponding to the one of the at least one frequency band, performing measurements on the at least one frequency corresponding to the one of the at least one frequency band without applying the compressed mode.

9. The apparatus of claim 8, wherein the measurement module is further configured for:
determining whether the one of the at least one frequency band is configured for communicating with the base station;
if the one of the at least one frequency band is configured for the user equipment to communicate with the base station, determining whether the compressed mode is to be applied on at least one frequency corresponding to the one of the at least one frequency band; and
if the one of the at least one frequency band is not configured for the user equipment to communicate with the base station, simultaneously applying a compressed mode on each of the configured frequency bands.

10. The apparatus of claim 9, wherein in the selectively applying of the compressed mode on the at least one frequency corresponding to the one of the at least one frequency band, the measurement module is configured for selectively applying the compressed mode on downlink carriers associated with one of a first frequency band and a second frequency band when a Radio Frequency (RF) chain is shared between the first frequency band and the second frequency band, wherein the first frequency band corresponds to a configured frequency band for communicating with the base station, and wherein the second frequency band corresponds to a frequency band on which measurements are to be performed.

11. The apparatus of claim 10, wherein in the selectively applying of the compressed mode on the carriers associated with one of the first frequency band and the second frequency band when the RF chain is shared between the first frequency band and the second frequency band, the measurement module is configured for communicating a RF chain split information to the base station.

12. The apparatus of claim 9, wherein in the selectively applying of the compressed mode on the at least one frequency corresponding to the one of the at least one frequency band, the measurement module is configured for selectively applying the compressed mode on one or more downlink carriers associated with the one of the at least one frequency band using an information element carrier index.

13. The apparatus of claim 8, wherein the measurement module is configured for reporting applicability of a compressed mode on the at least one frequency corresponding to the one of the at least one frequency band to the base station.

14. A method of performing measurements in a Long Term Evolution (LTE) network environment comprising:
receiving a request from a base station to perform measurements on at least one frequency corresponding to one of at least one frequency band;
determining whether a measurement gap is to be applied on the at least one frequency corresponding to the one of the at least one frequency band based on capabilities of a user equipment; and
if the measurement gap is to be applied on the at least one frequency, selectively activating the measurement gap on the at least one frequency corresponding to the one of the at least one frequency band so that measurements can be performed on the at least one frequency corresponding to the one of the at least one frequency band without interrupting data communication between the user equipment and the base station on the remaining frequency bands.

15. The method of claim 14, wherein the determining of whether the measurement gap is to be applied on the at least one frequency corresponding to the one of the at least one frequency band based on capabilities of the user equipment comprises:
if the measurement gap is not to be applied on the at least one frequency, performing measurements on the at least one frequency corresponding to the one of the at least one frequency band without activating the measurement gap.

16. The method of claim 14, wherein the receiving of the request from the base station to perform measurements on the at least one frequency corresponding to the one of the at least one frequency band comprises:
determining whether the one of the at least one frequency band is configured for the user equipment to communicate with the base station;
if the one of the at least one frequency band is configured for the user equipment to communicate with the base station, determining whether the measurement gap is to be applied on at least one frequency corresponding to the one of the at least one frequency band based on the capabilities of the user equipment; and
if the one of the at least one frequency band is not configured for the user equipment to communicate with the base station, simultaneously activating a measurement gap on each of the configured frequency bands.

17. The method of claim 16, wherein the selectively activating of the measurement gap on the at least one frequency corresponding to the one of the at least one frequency band comprises:
selectively activating the measurement gap on one or more component carriers associated with one of a first frequency band and a second frequency band when a Radio Frequency (RF) chain in the user equipment is shared between the first frequency band and the second frequency band, wherein the first frequency band corresponds to a frequency band that is configured for the user equipment to communicate with the base station, and wherein the second frequency band corresponds to a frequency band on which measurements are to be performed.

18. The method of claim 17, wherein the activating of the measurement gap on the one or more component carriers associated with one of the first frequency band and the second frequency band when the RF chain in the user equipment is shared between the first frequency band and the second frequency band comprises:
communicating a RF chain split information associated with the user equipment to the base station.

19. The method of claim 16, wherein the selectively activating of the measurement gap on the at least one frequency corresponding to the one of the at least one frequency band comprises:
selectively activating the measurement gap on one or more component carriers associated with the one of the frequency bands using at least one of an information element cell index and a measurement gap configuration.

20. The method of claim 16, wherein the simultaneously activating of the measurement gap on each of the configured frequency bands comprises:
activating a single measurement gap for all the component carriers associated with each of the configured frequency bands.

21. The method of claim 15, wherein the performing of the measurements on the at least one frequency corresponding to the one of the at least one frequency band without activating the measurement gap comprises:
performing measurements on the at least one frequency corresponding to the one of the at least one frequency band using one of deactivated component carriers, non-configured component carriers, and deactivated secondary cells.

22. The method of claim 14, further comprising:
reporting applicability of the measurement gap on the at least one frequency corresponding to the one of the at least one frequency band to the base station.

23. An apparatus comprising:
a processor; and
a memory coupled to the processor, wherein the memory includes a measurement module configured for:
receiving a request from a base station to perform measurements on at least one frequency corresponding to one of at least one frequency band;
determining whether a measurement gap is to be applied on the at least one frequency corresponding to the one of the at least one frequency band;
if the measurement gap is to be applied on the at least one frequency, selectively activating the measurement gap on the at least one frequency corresponding to the one of the at least one frequency band so that measurements can be performed on the at least one frequency corresponding to the one of the at least one frequency band without interrupting data activity over the remaining frequency bands; and
if the measurement gap is not to be applied on the at least one frequency, performing measurements on the at least one frequency corresponding to the one of the at least one frequency band without activating the measurement gap.

24. The apparatus of claim 23, wherein the measurement module is further configured for:
determining whether the one of the at least one frequency band is configured for communicating with the base station;
if the one of the at least one frequency band is configured for communicating with the base station, determining whether the measurement gap is to be applied on at least one frequency corresponding to the one of the at least one frequency band; and
if the one of the at least one frequency band is not configured for communicating with the base station, simultaneously activating a measurement gap on each of the configured frequency bands.

25. The apparatus of claim 24, wherein in the selectively activating of the measurement gap on the at least one frequency corresponding to the one of the at least one frequency band, the measurement module is configured for selectively activating the measurement gap on downlink carriers associated with one of a first frequency band and a second frequency band when a Radio Frequency (RF) chain is shared between the first frequency band and the second frequency band, wherein the first frequency band corresponds to a configured frequency band for communicating with the base station, and wherein the second frequency band corresponds to a frequency band on which measurements are to be performed.

26. The apparatus of claim 25, wherein in the selectively activating of the measurement gap on the carriers associated with one of the first frequency band and the second frequency band when the RF chain is shared between the first frequency band and the second frequency band, the measurement module is configured for communicating a RF chain split information to the base station.

27. The apparatus of claim 24, wherein in the selectively activating of the measurement gap on the at least one frequency corresponding to the one of the at least one frequency band, the measurement module is configured for selectively activating the measurement gap on one or more downlink carriers associated with the one of the frequency bands using at least one of an information element cell index and a measurement gap configuration.

28. The apparatus of claim 23, wherein the measurement module is configured for reporting applicability of the measurement gap on the at least one frequency corresponding to the one of the at least one frequency bands to the base station.
